(19) United States
(12) Patent Application Publication
(10) Pub. No.: US 2017/0222495 A1
(43) Pub. Date: Aug. 3, 2017

(54) Electric Motor and Method for Manufacturing the Same

(71) Applicant: Bigbest Solutions, Inc., Taichung City (TW)

(72) Inventors: Chia-Hung Hsu, Shetou Township (TW); Ray-Min Chen, Baoshan Township (TW)

(21) Appl. No.: 15/413,540

(22) Filed: Jan. 24, 2017

(30) Foreign Application Priority Data
Jan. 30, 2016 (TW) 105102989

(51) Int. Cl. H02K 1/14; H02K 15/02; H02K 1/27

(52) U.S. Cl. CPC H02K 1/141; H02K 1/2793; H02K 15/022

(57) ABSTRACT

An electric motor includes an inner rotor unit including a rotary body having an outer ring portion and multiple magnetic members mounted to the outer ring portion, and a stator unit including multiple alternately arranged first and second stators. Each first stator includes a first magnetic conductive member and a first coil. Each second stator includes a second magnetic conductive member disposed between two adjacent first stators, and a second coil . An imaginary circle is defined to be centered at a central point of the rotary body and to pass through central points of the first coils. The second coil of each of the second stators has a central point that does not lie on the imaginary circle.

### CROSS-REFERENCE TO RELATED APPLICATION

This application claims priority of Taiwanese Patent Application No. 105102989, filed on Jan. 30, 2016.

### FIELD

The disclosure relates to an electric motor and a method for manufacturing the same, and more particular to an electric motor including alternately arranged first and second stators and a method for manufacturing the electric motor.

### BACKGROUND

Referring to FIG. 1, a conventional electric motor includes an inner rotor unit 400 and a plurality of stators 500 arranged radially around the inner rotor unit 400. The inner rotor unit 400 includes a rotary body 410 and a plurality of magnetic members 420 that are mounted to the rotary body 410. Each of the stators 500 is wound with a coil (not shown), and the coil may be charged with electricity to interact with the magnetic members 420 of the rotor unit 400 and to drive rotation of the rotor unit 400.

The output power of the conventional electric motor is proportional to the coil turn number of each of the stators 500. However, for each of the stators 500, the space for the stator 500 to be wound with the coil is limited by two adjacent ones of the stators 500, resulting in limitation of motor output power.

### SUMMARY

Therefore, an object of the present disclosure is to provide an electric motor and a method for manufacturing the electric motor that can alleviate at least one of the drawbacks associated with the prior art.

According to one aspect of the present disclosure, an electric motor includes an inner rotor unit and a stator unit.

The inner rotor unit includes a rotary body that is rotatable about an axis and that has an outer ring portion at an outer periphery of the rotary body, and a plurality of magnetic members that are mounted to the outer ring portion of the rotary body.

The stator unit includes a plurality of first stators and a plurality of second stators that are arranged alternately around the outer ring portion of the rotary body. Each of the first stators includes a first magnetic conductive member and a first coil that is wound on the first magnetic conductive member. Each of the second stators includes a second magnetic conductive member that is disposed between two adjacent ones of the first stators, and a second coil that is wound on the second magnetic conductive member.

An imaginary circle is defined to be centered at a central point of the rotary body and to pass through central points of the first coils of the first stators. The second coil of each of the second stators has a central point that does not lie on the imaginary circle.

According to another aspect of the pre sent disclosure, a method for manufacturing an electric motor includes the steps of:

(1) forming a plurality of first magnetic conductive sheets that are made of silicon steel and that are substantially U-shaped;

(2) forming a plurality of second magnetic conductive sheets that are made of silicon steel, that are substantially U-shaped, and that are shaped differently from the first magnetic conductive sheets;

(3) forming the first magnetic conductive sheets into a plurality of first magnetic conductive members, such that each of the first magnetic conductive members includes a selected number of the first magnetic conductive sheets that are stacked together and that are interconnected fixedly;

(4) forming the second magnetic conductive sheets into a plurality of second magnetic conductive members, such that each of the second magnetic conductive members includes a selected number of the second magnetic conductive sheets that are stacked together and that are interconnected fixedly;

(5) winding a plurality of first coils respectively on the first magnetic conductive members to form a plurality of first stators;

(6) winding a plurality of second coils respectively on the second magnetic conductive members to form a plurality of second stators; and

(7) alternately arranging the first stators and the second stators around a rotary body that is rotatable about an axis.

### BRIEF DESCRIPTION OF THE DRAWINGS

Other features and advantages of the present disclosure will become apparent in the following detailed description of the embodiments with reference to the accompanying drawings, of which:

FIG. 1 is a partly exploded perspective view of a conventional electric motor;

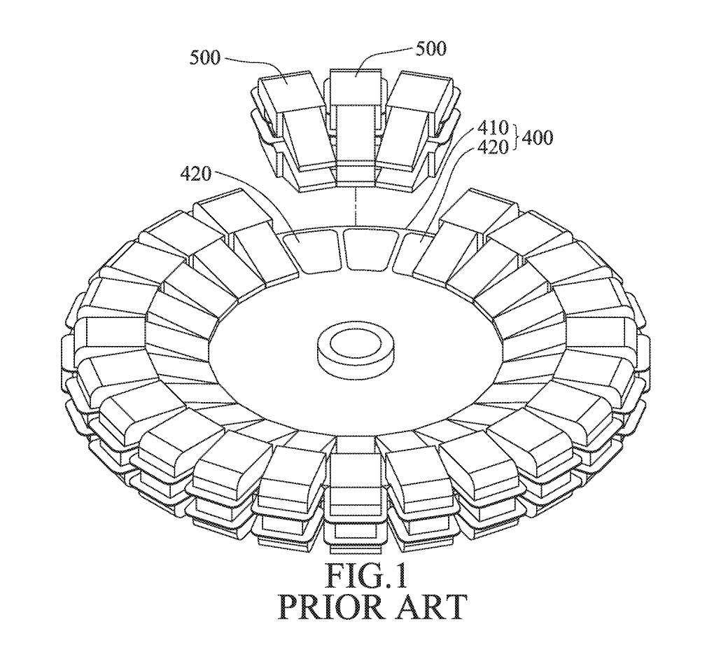

FIG. 2 is a partly exploded perspective view of a first embodiment of the electric motor according to the present disclosure;

FIG. 3 is a top view of the first embodiment;

FIG. 4 is a sectional view of the first embodiment taken along line IV-IV of FIG. 3;

FIG. 5 is a partly exploded perspective view of a second embodiment of the electric motor according to the present disclosure;

FIG. 6 is a top view of the second embodiment;

FIG. 7 is a sectional view of the second embodiment taken along line VII-VII of FIG. 6; and

FIG. 8 is a flow chart illustrating a method for manufacturing the electric motor according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

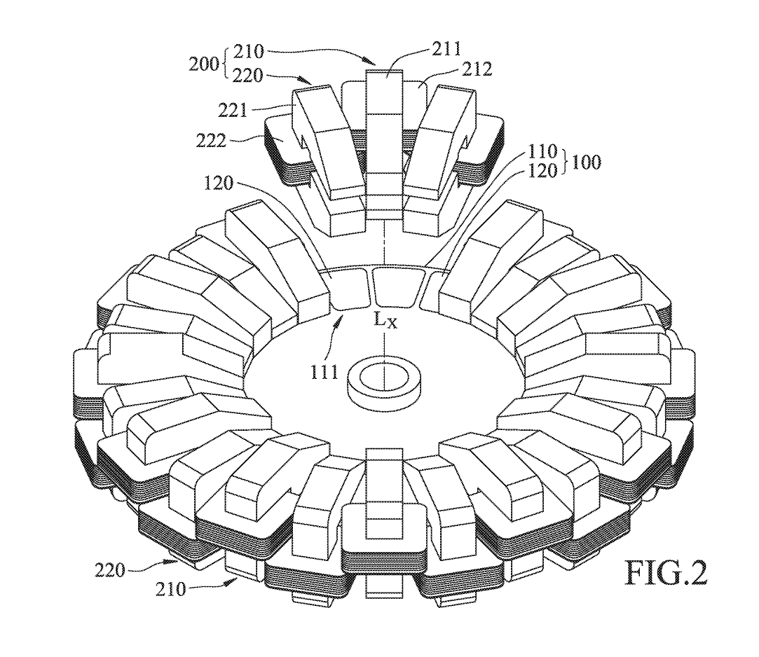

Referring to FIGS. 2 to 4, the first embodiment of the electric motor according to the present disclosure includes an inner rotor unit 100 and a stator unit 200.

The inner rotor unit 100 includes a rotary body 110 and a plurality of magnetic members 120. The rotary body 110 is rotatable about an axis (L_{X}) and has an outer ring portion 111 at an outer periphery of the rotary body 110. The magnetic members 120 are mounted to the outer ring portion 111 of the rotary body 110.

The stator unit 200 includes a plurality of first stators 210 and a plurality of second stators 220 that are arranged alternately around the outer ring portion 111 of the rotary body 110. Each of the first stators 210 includes a first magnetic conductive member 211 and a first coil 212 that is wound on the first magnetic conductive member 211. Each of the second stators 220 includes a second magnetic conductive member 221 that is disposed between two adjacent ones of the first stators 210, and a second coil 222 that is wound one the second magnetic conductive member 221.

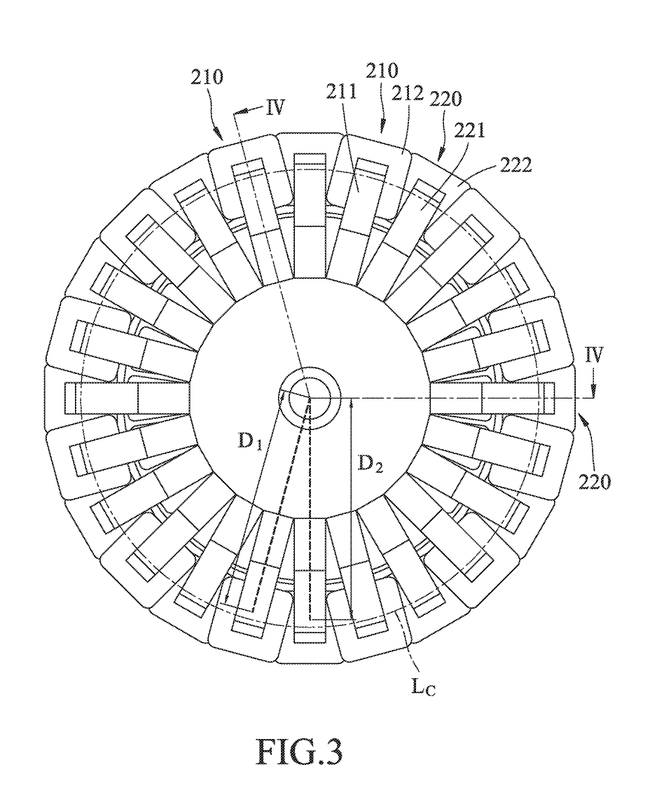

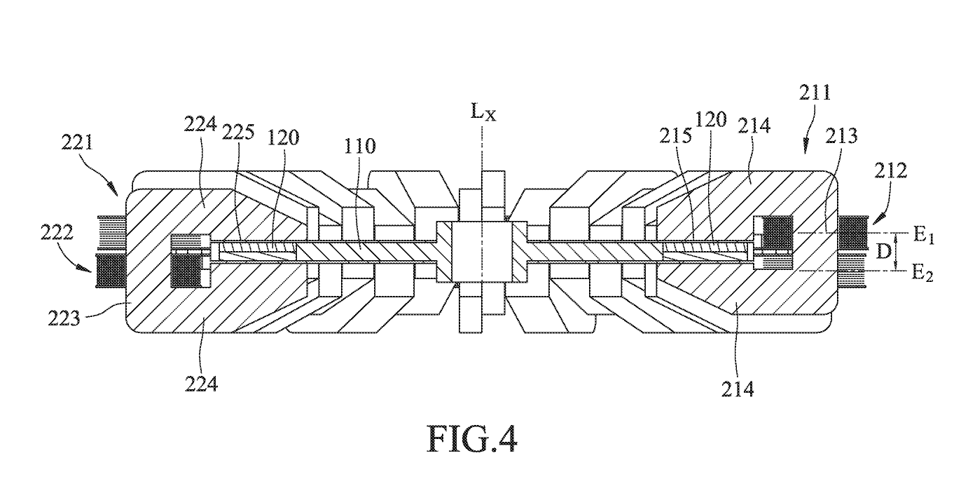

Referring to FIGS. 3 and 4, an imaginary circle (L_{C}) is defined to be centered at a central point of the rotary body 110 and to pass through central points of the first coils 212 of the first stators 210. The second coil 222 of each of the second stators 220 has a central point that does not lie on the imaginary circle (L_{C}).

Specifically, in this embodiment, the first magnetic conductive member 211 of each of the first stators 210 has a first coil winding portion 213 on which a corresponding one of the first coils 212 is wound, two first extending portions 214 that respectively extend from opposite ends of the first coil winding portion 213 and toward the axis (L_{X}), and a first channel 215 that is defined by the first coil winding portion 213 and the first extending portions 214. The second magnetic conductive member 221 of each of the second stators 220 has a second coil winding portion 223 on which a corresponding one of the second coils 222 is wound, two second extending portions 224 that respectively extend from opposite ends of the second coil winding portion 223 toward the axis (L_{X}), and a second channel 225 that is defined by the second coil winding portion 223 and the second extending portions 224. The rotary body 110 of the inner rotor unit 100 is partially received in and is rotatable in the first channel 215 of the first magnetic conductive member 221 of each of the first stators 210 and the second channel 225 of the second magnetic conductive member 221 of each of the second stators 220.

A first imaginary plane (E₁) is defined such that a central point of the first coil winding portion 213 of the first magnetic conductive member 211 of each of the first stators 210 lies on the first imaginary plane (E₁). A second imaginary plane (E₂) is defined such that a central point of the second coil winding portion 223 of the second magnetic conductive member 221 of each of the second stators 220 lies on the second imaginary plane (E₂). The first imaginary plane (E₁) and the second imaginary plane (E₂) are spaced apart from each other along the axis (L_{X}) by a distance (D), and are parallel to each other. A first distance (D₁) is defined between the central point of the first coil winding portion 213 of the first magnetic conductive member 211 of each of said first stators 210 and the central point of the rotary body 110. A second distance (D₂) is defined between the central point of the second coil winding portion 223 of the second magnetic conductive member 221 of each of the second stators 220 and the central point of the rotary body 110. The first distance (D₁) equals to the second distance (D₂).

With such configuration, a maximum space around the first coil winding portion 213 of the first magnetic conductive member 211 of each of the first stators 210 for the corresponding one of the first coils 212 to be wound thereon is extended to peripheries of two adjacent ones of the second stators 220. Similarly, a maximum space around the second coil winding portion 223 of the second magnetic conductive member 221 of each of the second stators 220 for the corresponding one of the second coils 222 to be wound thereon is extended to peripheries of two adjacent ones of the first stators 210.

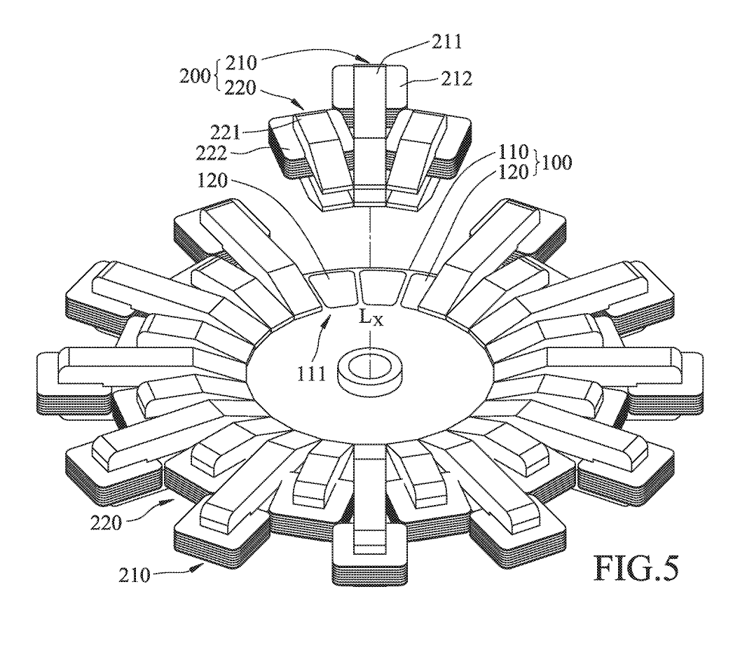

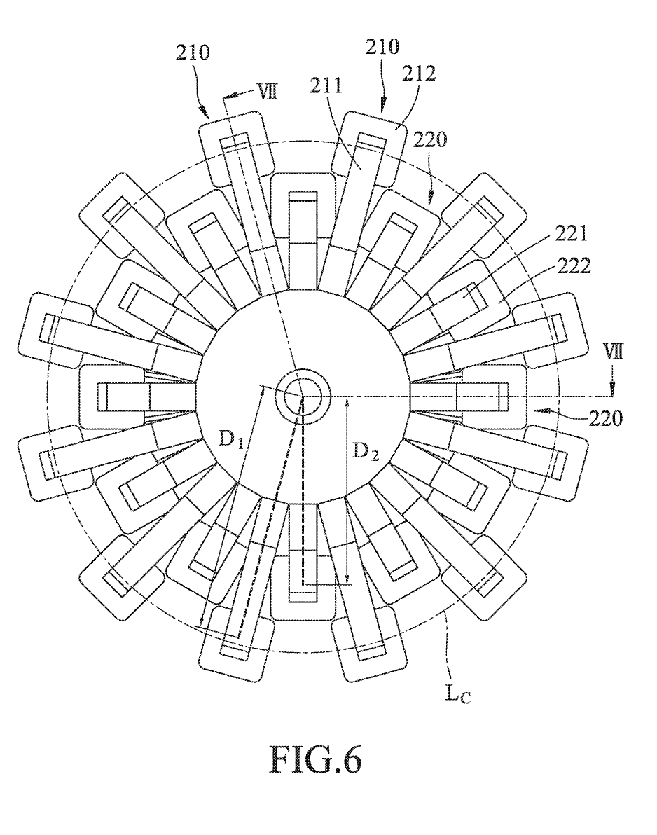

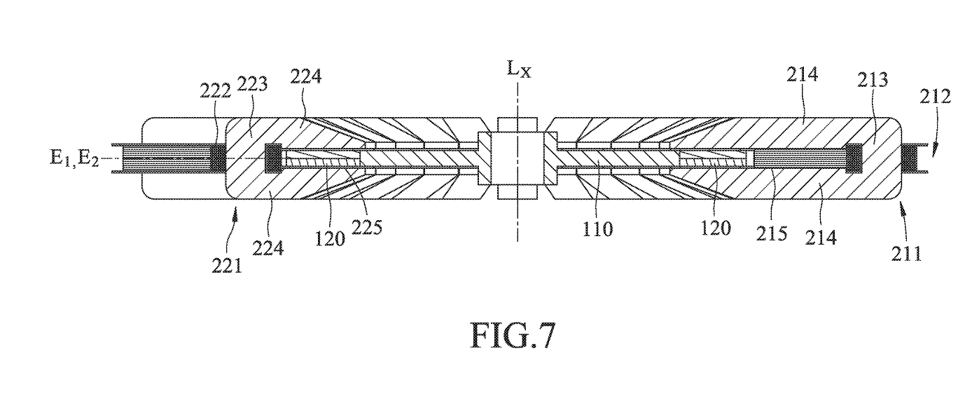

Referring to FIGS. 5 to 7, a second embodiment of the electric motor according to the present disclosure has a structure similar to that of the first embodiment, with differences described below. In the second embodiment, the first imaginary plane (E₁) is substantially coplanar with the second imaginary plane (E₂), and the first distance (D₁) is greater than (i.e., different from) the second distance (D₂), which can be achieved by using the first stators 210 and the second stators 220 of different structures that may be changed according to practical requirements. It is worth mentioning that the term “substantially coplanar” means that the first imaginary plane (E₁) maybe slightly off set from the second imaginary plane (E₂) due to small assembly error, which is acceptable in practical application as long as the electric motor is functional. Such error may vary based on actual requirements and structure of the electric motor.

With such configuration, the maximum space around the first coil winding portion 213 of the first magnetic conductive member 211 of each of the first stators 210 for the corresponding one of the first coils 212 to be wound thereon is extended to peripheries of two adjacent ones of the second stators 220. Although the maximum space around the second coil winding portion 223 of the second magnetic conductive member 221 of each of the second stators 220 for the corresponding one of the second coils 222 to be wound thereon is limited by peripheries of two adjacent ones of the first stators 210, the maximum space can be extended into the first channels 215 of the first magnetic conductive members 211 of the two adjacent first stators 210.

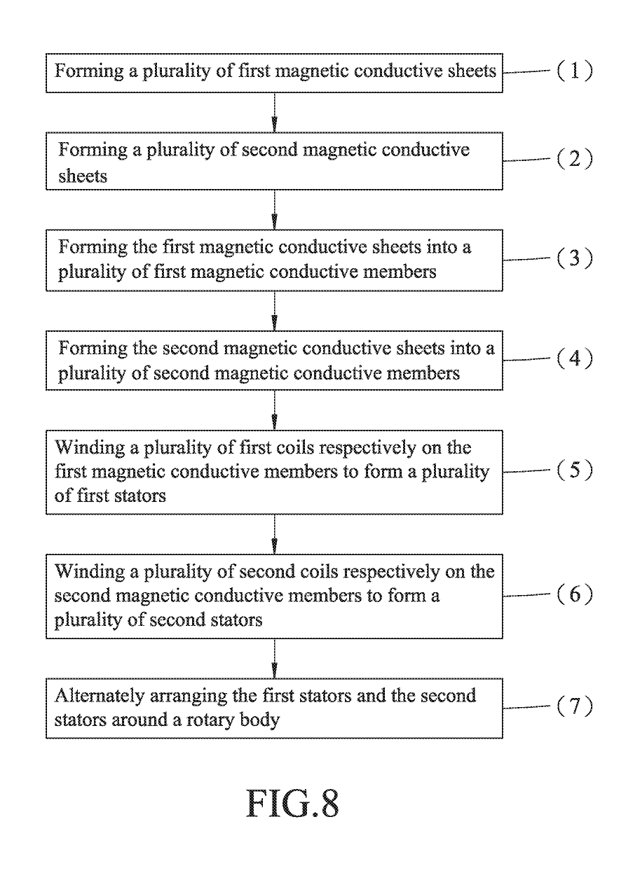

Referring to FIG. 8, a method for manufacturing the electric motor of the present disclosure includes the steps of:

(1) forming a plurality of first magnetic conductive sheets that are made of silicon steel and that are substantially U-shaped;

(2) forming a plurality of second magnetic conductive sheets that are made of silicon steel, that are substantially U-shaped, and that are shaped differently from the first magnetic conductive sheets;

(3) forming the first magnetic conductive sheets into the first magnetic conductive members 211, such that each of the first magnetic conductive members 211 includes a selected number of the first magnetic conductive sheets that are stacked together and that are interconnected fixedly;

(4) forming the second magnetic conductive sheets into the second magnetic conductive members 221, such that each of the second magnetic conductive members 221 includes a selected number of the second magnetic conductive sheets that are stacked together and that are interconnected fixedly;

(5) winding the first coils 212 respectively on the first magnetic conductive members 211 to form the first stators 210;

(6) winding the second coils 222 respectively on the second magnetic conductive members 221 to form the second stators 220; and

(7) alternately arranging the first stators 210 and the second stators 220 around the rotary body 110, which is partially and rotatably received in the first channel 215 of each of the first magnetic conductive members 211 and the second channel 225 of each of the second magnetic conductive members 221.

In the steps (3) and (4) of the method, the first and second magnetic conductive members 211, 221 are arranged such that:
the first imaginary plane (E₁) is defined so that the central point of the first coil winding portion 213 of each of the first magnetic conductive members 211 lies on the first imaginary plane (E₁); and
the second imaginary plane (E₂) is defined so that the central point of the second coil winding portion 223 of each of the second magnetic conductive members 221 lies on the second imaginary plane (E₂).

In the method for manufacturing the first embodiment, in the steps (3) and (4), the first and second magnetic conductive members 211, 221 are arranged such that the first imaginary plane (E₁) and the second imaginary plane (E₂) are spaced apart from each other along the axis (L_{X}) by the distance (D), and are parallel to each other. Moreover, in the step (7), the first stators 210 and the second stators 220 are positioned relative to the rotary body 110 such that: the first distance (D₁) is defined between the central point of the first coil winding portion 213 of each of the first magnetic conductive members 211 and the central point of the rotary body 110; the second distance (D₂) is defined between the central point of the second coil winding portion 223 of each of the second magnetic conductive members 221 and the central point of the rotary body 110; and the first distance (D₁) equals to the second distance (D₂).

Alternatively, in the method for manufacturing the second embodiment, in the steps (3) and (4), the first and second magnetic conductive members 211, 221 are arranged such that the first imaginary plane (E₁) are coplanar with the second imaginary plane (E₂). Moreover, in the step (7), the first stators 210 and the second stators 220 are positioned relative to the rotary body 110 such that: the first distance (D₁) is defined between the central point of the first coil winding portion 213 of each of the first magnetic conductive members 211 and the central point of the rotary body 110; the second distance (D₂) is defined between the central point of the second coil winding portion 223 of each of the second magnetic conductive members 221 and the central point of the rotary body 110; and the first distance (D₁) is greater than (i.e., different from) the second distance (D₂).

To sum up, with the specific arrangement of the stators, the maximum space for the coils to be wound thereon is extended and enlarged, thereby alleviating at least one of the drawbacks associated with the prior art.

In the description above, for the purposes of explanation, numerous specific details have been set forth in order to provide a thorough understanding of the embodiments. It will be apparent, however, to one skilled in the art, that one or more other embodiments may be practiced without some of these specific details . It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An electric motor comprising:
an inner rotor unit including a rotary body that is rotatable about an axis and that has an outer ring portion at an outer periphery of said rotary body, and a plurality of magnetic members that are mounted to said outer ring portion of said rotary body; and
a stator unit including a plurality of first stators and a plurality of second stators that are arranged alternately around said outer ring portion of said rotary body, each of said first stators including a first magnetic conductive member and a first coil that is wound on said first magnetic conductive member, each of said second stators including a second magnetic conductive member that is disposed between two adjacent ones of said first stators, and a second coil that is wound on said second magnetic conductive member,
wherein an imaginary circle is defined to be centered at a central point of said rotary body and to pass through central points of said first coils of said first stators, and said second coil of each of said second stators has a central point that does not lie on said imaginary circle.

2. The electric motor as claimed in claim 1, wherein:
said first magnetic conductive member of each of said first stators has a first coil winding portion, on which a corresponding one of said first coils is wound;
said second magnetic conductive member of each of said second stators has a second coil winding portion, on which a corresponding one of said second coils is wound;
a first imaginary plane is defined such that a central point of said first coil winding portion of said first magnetic conductive member of each of said first stators lies on the first imaginary plane; and
a second imaginary plane is defined such that a central point of said second coil winding portion of said second magnetic conductive member of each of said second stators lies on the second imaginary plane.

3. The electric motor as claimed in claim 2, wherein the first imaginary plane and the second imaginary plane are spaced apart from each other along the axis, and are parallel to each other.

4. The electric motor as claimed in claim 3, wherein:
a first distance is defined between said central point of said first coil winding portion of said first magnetic conductive member of each of said first stators and said central point of said rotary body;
a second distance is defined between said central point of said second coil winding portion of said second magnetic conductive member of each of said second stators and said central point of said rotary body; and
the first distance equals to the second distance.

5. The electric motor as claimed in claim 2, wherein:
a first distance is defined between said central point of said first coil winding portion of said first magnetic conductive member of each of said first stators and said central point of said rotary body;
a second distance is defined between said central point of said second coil winding portion of said second magnetic conductive member of each of said second stators and said central point of said rotary body;
the first distance is greater than the second distance; and
the first imaginary plane is coplanar with the second imaginary plane.

6. The electric motor as claimed in claim 2, wherein:
said first magnetic conductive member of each of said first stators further has two first extending portions that respectively extend from opposite ends of said first coil winding portion toward the axis, and a first channel that is defined by said first coil winding portion and said first extending portions;
said second magnetic conductive member of each of said second stators further has two second extending portions that respectively extend from opposite ends of said second coil winding portion toward the axis, and a second channel that is defined by said second coil winding portion and said second extending portions; and
said rotary body of said inner rotor unit is partially received in and is rotatable in said first channel of said first magnetic conductive member of each of said first stators and said second channel of said second magnetic conductive member of each of said second stators.

7. A method for manufacturing an electric motor, comprising the steps of:
(1) forming a plurality of first magnetic conductive sheets that are made of silicon steel and that are substantially U-shaped;
(2) forming a plurality of second magnetic conductive sheets that are made of silicon steel, that are substantially U-shaped, and that are shaped differently from the first magnetic conductive sheets;
(3) forming the first magnetic conductive sheets into a plurality of first magnetic conductive members, such that each of the first magnetic conductive members includes a selected number of the first magnetic conductive sheets that are stacked together and that are interconnected fixedly;
(4) forming the second magnetic conductive sheets into a plurality of second magnetic conductive members, such that each of the second magnetic conductive members includes a selected number of the second magnetic conductive sheets that are stacked together and that are interconnected fixedly;
(5) winding a plurality of first coils respectively on the first magnetic conductive members to form a plurality of first stators;
(6) winding a plurality of second coils respectively on the second magnetic conductive members to form a plurality of second stators; and
(7) alternately arranging the first stators and the second stators around a rotary body that is rotatable about an axis.

8. The method as claimed in claim 7, wherein in the step (7), the rotary body is partially and rotatably received in a first channel of each of the first magnetic conductive members and a second channel of each of the second magnetic conductive members.

9. The method as claimed in claim 8, wherein in the steps (3) and (4), the first and second magnetic conductive members are arranged such that:
a first imaginary plane is defined so that a central point of a first coil winding portion of each of the first magnetic conductive members lies on the first imaginary plane; and
a second imaginary plane is defined so that a central point of a second coil winding portion of each of the second magnetic conductive members lies on the second imaginary plane.

10. The method as claimed in claim 9, wherein in the steps (3) and (4), the first and second magnetic conductive members are arranged such that the first imaginary plane and the second imaginary plane are spaced apart from each other along the axis, and are parallel to each other.

11. The method as claimed in claim 10, wherein in the step (7), the first stators and the second stators are positioned relative to the rotary body such that:
a first distance is defined between the central point of a first coil winding portion of each of the first magnetic conductive members and a central point of the rotary body;
a second distance is defined between the central point of a second coil winding portion of each of the second magnetic conductive members and the central point of the rotary body; and
the first distance equals to the second distance.

12. The method as claimed in claim 9, wherein in the steps (3) and (4), the first and second magnetic conductive members are arranged such that the first imaginary plane are coplanar with the second imaginary plane.

13. The method as claimed in claim 12, wherein in the step (7), the first stators and the second stators are positioned relative to the rotary body such that:
a first distance is defined between the central point of a first coil winding portion of each of the first magnetic conductive members and a central point of the rotary body;
a second distance is defined between the central point of a second coil winding portion of each of the second magnetic conductive members and the central point of the rotary body; and
the first distance is different from the second distance.
